(19) United States
(12) Patent Application Publication
(10) Pub. No.: US 2023/0289010 A1
(43) Pub. Date: Sep. 14, 2023

(54) PROXIMITY DETECTION DEVICE AND HOVER DETECTION METHOD

(71) Applicant: ALPS ALPINE CO., LTD., Tokyo (JP)

(72) Inventor: Teiichi Ichikawa, Iwaki (JP)

(73) Assignee: ALPS ALPINE CO., LTD., Tokyo (JP)

(21) Appl. No.: 18/108,295

(22) Filed: Feb. 10, 2023

(30) Foreign Application Priority Data
Mar. 9, 2022 (JP) 2022-035919

(51) Int. Cl. G06F 3/041; G06F 3/044

(52) U.S. Cl. CPC G06F 3/04166; G06F 3/0446; G06F 2203/04108

(57) ABSTRACT

A proximity detection device includes a detection controller and a touch panel. The detection controller includes a drive unit that drives a sensor line on an X side or a Y side, a measurement unit that measures capacitance Cm, Cpx, and Cpy formed by the sensor line on the X side or the Y side, and a detection unit that performs touch detection or hover detection based on the capacitance Cm, Cpx, and Cpy measured by the measurement unit. When detecting a hover, the drive unit changes a frequency of the drive signal that drives the sensor line on the X side or the Y side and this improves a hover detection sensitivity.

### REFERENCE TO RELATED APPLICATION

The present application claims priority to Japanese Patent Application Number 2022-035919, filed Mar. 9, 2022, the entirety of which is hereby incorporated by reference.

### BACKGROUND

### 1. Field of the Invention

The present disclosure relates to a proximity detection device that detects the proximity of an object, and more particularly to a method of detecting the proximity (hover) of an object using a capacitive touch panel.

### 2. Description of the Related Art

A touch panel is mounted in a display unit integrally with a liquid crystal panel or the like as an input interface for receiving an instruction from a user. For example, JP 2011-8725 A and JP 2017-182185 A disclose capacitive touch sensors. In addition, WO 2018/116706 A discloses a capacitance detection device for detecting an approach of an operation target, and describes a technique for suppressing a decrease in detection sensitivity due to the influence of a parasitic capacitor.

### SUMMARY

FIG. 1 illustrates an example of a sensor pattern of a capacitive touch panel. The sensor pattern illustrated in the figure is referred to as a diamond pattern, and M pieces of sensors (Sx1, Sx2, . . . , SxM) arranged in the X direction and N pieces of sensors (Sy1, Sy2, . . . , SyN) arranged in the Y direction cross each other, and at the intersection, the sensors in the X direction and the sensors in the Y direction are wired by a bridge so as not to come into contact with each other. As an example of the operation of the touch sensor, when the sensors Syj (j=1, . . . , N) arranged in the Y direction are driven, the touch operation at the intersection of the sensors Sxi and Syj is detected based on the change in amount of the capacitance value Cm [i, j] obtained by each of the sensors Sxi (i=1, . . . , M) arranged in the X direction (generally referred to as a mutual capacitance type). FIG. 1 illustrates an example in which the capacitance Cm [4, 3] at the intersection is measured by the sensor Sx4 when a drive pulse is applied to the sensor Sy3. For example, when there is a finger touch, the capacitance Cm at that location is measured to be smaller.

In recent years, an approach (hover) of a finger before touching is detected using this sensor pattern. The change in capacitance caused by to the hover is much smaller than the change in capacitance caused by a touch, and sufficient sensitivity cannot be obtained by the method of detecting the capacitance at the intersection of the sensors Syj and Sxi as described above. Therefore, in the hover detection, a TP-GND layer parallel to the sensor pattern is arranged on the bottom surface as illustrated in FIG. 2, and a change in capacitance Cp between each sensor pattern (Sxi, Syj) and the TP-GND layer is detected. Specifically, each of the sensor lines Sxi and Syj is driven, and a change in capacitance of the driven sensor line itself is detected (generally referred to as a self-capacitance method). For example, when a finger approaches, the capacitance Cp at that location is measured to increase.

FIG. 3 is an equivalent circuit obtained by extracting one sensor in the X direction and one sensor in the Y direction from the sensor pattern of the capacitive touch panel illustrated in FIG. 2. A detection controller 10 applies a drive signal to the sensor line in the X direction or the Y direction, and detects the touch location based on the capacitance Cm measured by the sensor line in the Y direction or the X direction. In addition, the detection controller 10 measures its own capacitance Cpx when the sensor line Sx is driven, measures its own capacitance Cpy when the sensor line Sy is driven, and detects the hover location based on Cpx and Cpy.

To detect a touch location, capacitance Cm[i, j] formed between the sensor lines Sxi and Syj is measured, and to detect a hover location, capacitance Cpx[i] and capacitance Cpy[j] formed between Sxi, Syj and GND are measured. Here, Cp (Cpx[i] and Cpy[i]) formed by the entire sensor line and the TP-GND layer is much larger than the capacitance Cm formed at the intersection of the sensor lines, and the capacitance Cp is several 100 pF (picofarads: ×10⁻¹² F), for example, in a general in-vehicle size touch panel. On the other hand, since the capacitance change of the capacitance Cp caused by a hover of a finger is several 10 fF (femtofarads: ×10⁻¹⁵ F), it is necessary to detect a capacitance change of the order of 1/10,000 (10⁻⁴) for the hover detection, and it is difficult to accurately detect the capacitance change.

Therefore, in order to improve the hover detection sensitivity, there is a method of driving the TP-GND layer with the same sine wave (sinusoidal wave) as the sensor line Sxi or Syj. The figure illustrates a state in which the sensor line Syj is detected, and the detection controller 10 drives the sensor line Syj and the TP-GND layer with a sine wave. When the sensor line Sxi is detected, the sensor line Sxi and the TP-GND layer are driven by the same sine wave.

According to this driving system, since both ends of Cpy[j] are driven with the same waveform, the influence of the parasitic capacitance Cpy[j] is canceled in the measurement result, and ideally, only the capacitance change caused by the approach of the finger is detected. However, actually, since the electrical characteristics of the path through which the two sine waves reach both ends of Cpy[j] are different, the waveforms applied to both ends of Cpy[j] do not completely match, and Cpy[j] cannot be completely canceled. Still, the apparent Cp value can be reduced to several pF, and a capacity change of several 10 fF (femtofarads) caused by the hover can be detected on the order of 1/100 (10⁻²).

FIG. 4 is a timing chart of driving/measurement when the hover detection and the touch detection are performed. As illustrated in the drawing, the detection controller 10 detects Cpx[i], Cpy[j], and Cm[i, j] in a time division manner in one cycle. However, it is also possible to alternately detect Cpx and Cpy once every two cycles.

In the hover detection method in which the sensor line and the TP-GND layer are driven by the same sine wave, when pattern wiring in an actual touch panel is taken into consideration, for example, as illustrated in FIG. 5, a connector 20 is arranged at the lower part of the screen of the display, and the TP-GND line is electrically connected only at the lower part of the TP-GND layer via the connector 20. If the entire circumference of the TP-GND layer can be connected to the TP-GND line, a stronger TP-GND layer can be realized, but in this case, the wiring area of the sensor and the pattern of the TP-GND increases, and this causes a design problem such as inability to realize a narrow frame for the display screen. Therefore, the connector 20 is connected to a lower portion of the TP-GND layer.

Considering that the sensor line Sy1 at the top of the screen and the sensor line SyN at the bottom measure the capacitances Cpy[1] and Cpy[N] respectively formed between the sensor line Sy1 and the TP-GND layer and between the sensor line SyN and the TP-GND layer, the TP-GND line when measuring Cpy [1] reaches Cpy[1] from the connector 20 through a large portion of the TP-GND layer. The TP-GND layer is generally formed of thin and transparent ITO or the like, and has a corresponding surface resistance. Therefore, the attenuation of the drive signal of the TP-GND layer when measuring Cpy[1] is larger than that of the drive signal when measuring Cpy[N] by an RC filter defined by the surface resistance and the parasitic capacitance.

As described above, since the attenuation amount of the drive signal of the TP-GND layer varies depending on the difference in the location in the Y direction on the screen, the difference between the drive signal of the sensor line on the upper side and the drive signal of the TP-GND layer increases, and the apparent Cp value varies for each sensor line in the Y direction as illustrated in FIG. 6. On the other hand, since the change in capacitance caused by the approach of the finger is constant regardless of the location on the screen, there is a problem that the sensitivity of the hover detection at the upper part of the screen is lowered compared to the sensitivity of the hover detection at the lower part of the screen, and the sensitivity of the hover detection differs depending on the location on the screen.

An object of the present disclosure is to provide a proximity detection device and a hover detection method that solve the above-described conventional problems and improve the sensitivity of hover detection.

A proximity detection device according to the present disclosure includes a touch panel including a plurality of sensor lines on an X side, a plurality of sensor lines on a Y side intersecting the plurality of sensor lines on the X side, a planar GND layer arranged to face the sensor lines on the X side and the Y side, and a connection portion electrically connected to a selected position of the GND layer, and a detection unit configured to detect a hover (approach) of an object to the touch panel based on a change in capacitance formed between a selected sensor line on the X side or the Y side and the GND layer, in which when detecting a hover, the detection unit applies a drive signal to the selected sensor line on the X side or the Y side and applies a drive signal having the same waveform as the drive signal to the GND layer via the connection portion, and the detection unit further changes a frequency of the drive signal according to a position of the selected sensor line.

In one aspect, the detection unit makes a frequency of the drive signal applied to a sensor line away from the connection portion smaller than a frequency of a drive signal applied to the sensor line close to the connection portion. In one aspect, the detection unit selects a predetermined number of a plurality of sensor lines from the plurality of sensor lines, and simultaneously applies the drive signal to the selected plurality of sensor lines. In one aspect, when the connection portion is connected to a left side or a right side of the rectangular GND layer, the detection unit changes a frequency of the drive signal applied to a sensor line extending in parallel with the direction of the left side or the right side. In one aspect, when the connection portion connection portion is connected to an upper side or a lower side of the rectangular GND layer, the detection unit changes a frequency of the drive signal applied to a sensor line extending in parallel with a direction of the upper side or the lower side. In one aspect, the detection unit detects a touch on the touch panel based on a change in the capacitance formed at an intersection of the sensor line on the X side and the sensor line on the Y side, in addition to the hover detection. In one aspect, the detection unit performs the hover detection by the sensor line on the X side, the hover detection by the sensor line on the Y side, and the touch detection by the sensor lines on the X side and the Y side in one cycle. In one aspect, the drive signal is a sine wave (sinusoidal wave).

A hover detection method according to the present disclosure relates to a method of a proximity detection device including a touch panel that includes a plurality of sensor lines on an X side, a plurality of sensor lines on a Y side intersecting the plurality of sensor lines on the X side, a planar GND layer arranged to face the sensor lines on the X side and the Y side, and a connection portion electrically connected to a selected position of the GND layer, and the hover detection method includes applying a drive signal to the selected sensor line on the X side or the Y side, applying a drive signal having the same waveform as the drive signal to the GND layer via the connection portion, and changing a frequency of the drive signal according to a position of the selected sensor line; and detecting a hover of an object to the touch panel based on a change in capacitance formed between the selected sensor line on the X side or the Y side and the GND layer. In one aspect, a frequency of the drive signal applied to the sensor line away from the connection portion is made smaller than a frequency of the drive signal applied to the sensor line close to the connection portion.

According to the present disclosure, when the hover detection is performed, the frequency of the drive signal is changed according to the location of the selected sensor line, so that the apparent capacitance of the sensor line to be measured can be reduced, thereby improving the sensing accuracy of the hover detection.

### BRIEF DESCRIPTION OF THE DRAWINGS

FIG. 1 is a plan view illustrating an example of a sensor pattern of a capacitive touch panel;

FIG. 2 is a perspective view illustrating a sensor structure for detecting a hover in the touch panel;

FIG. 3 is a diagram illustrating an equivalent circuit of the capacitive touch panel;

FIG. 4 is a diagram illustrating timings of hover detection and touch detection in the capacitive touch panel;

FIG. 5 is a diagram for explaining electrical connection of a TP-GND layer when the touch panel is mounted on a display unit;

FIG. 6 is a diagram for explaining a problem of a conventional capacitive touch panel;

FIG. 7 is a diagram illustrating a configuration of a capacitive proximity detection device according to a first embodiment of the present invention;

FIG. 8 is a diagram illustrating a drive waveform when a sensor line Syj is driven by a self-capacitance method;

FIG. 9 is a diagram illustrating a control example of a driving frequency for each sensor line according to the first embodiment of the present invention;

FIG. 10 is a graph illustrating an apparent Cp value for each sensor line according to the first embodiment of the present invention;

FIGS. 11A and 11B are diagrams for explaining a configuration of a proximity detection device according to a second embodiment of the present invention;

FIG. 12 is a diagram illustrating a control example of a driving frequency for each sensor line according to the second embodiment of the present invention;

FIG. 13 is a graph illustrating an apparent Cp value for each sensor line according to the second embodiment of the present invention;

FIG. 14 is a perspective view illustrating a sensor structure of a touch panel according to a third embodiment of the present invention;

FIG. 15 is a diagram illustrating a control example of a driving frequency for each sensor line according to the third embodiment of the present invention;

FIG. 16 is a graph illustrating an apparent Cp value for each sensor line according to the third embodiment of the present invention;

FIG. 17 is a diagram illustrating a control example of a driving frequency for each sensor line according to a fourth embodiment of the present invention; and

FIG. 18 is a diagram illustrating timing of hover detection and touch detection according to the fourth embodiment of the present invention.

### DETAILED DESCRIPTION OF THE PREFERRED EMBODIMENTS

Embodiments of the present invention will be now described. A proximity detection device according to the present disclosure includes a capacitive touch panel, and detects a hover (approach) or a contact of an operation target (for example, an object such as user's finger). The proximity detection device according to the present disclosure is not particularly limited, but provides a display device or a display unit mounted on a display such as a liquid crystal panel and having a user interface function. Such a display device is used in, for example, an in-vehicle device, a multifunctional mobile phone (smartphone), a portable information terminal (tablet computer, laptop computer, notebook computer), and the like.

Next, embodiments of the present invention will be described with reference to the drawings. FIG. 7 is a block diagram illustrating a configuration of the proximity detection device according to an embodiment of the present invention. The proximity detection device 100 includes a capacitive touch panel 120 and a detection controller 110 that detects a hover (approach) or a touch (contact) of an operation target to the touch panel 120.

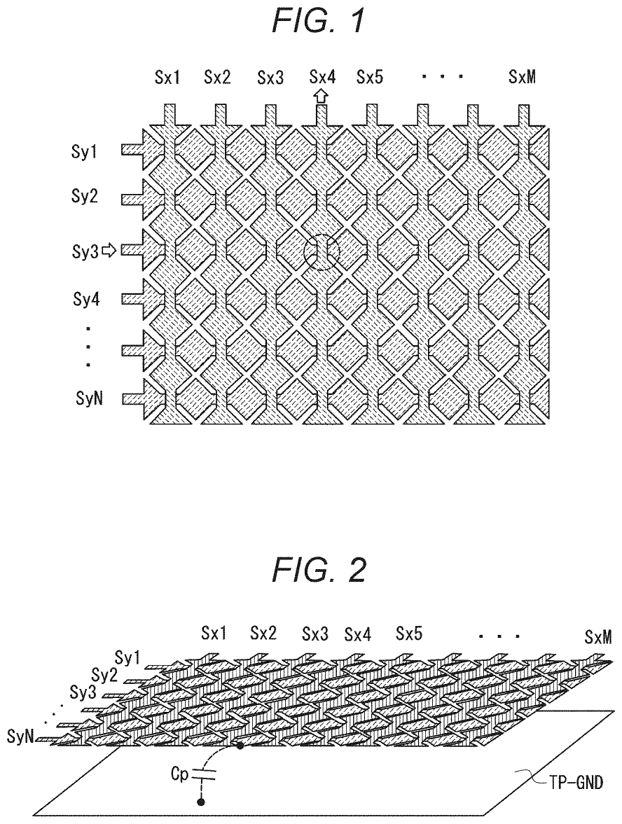

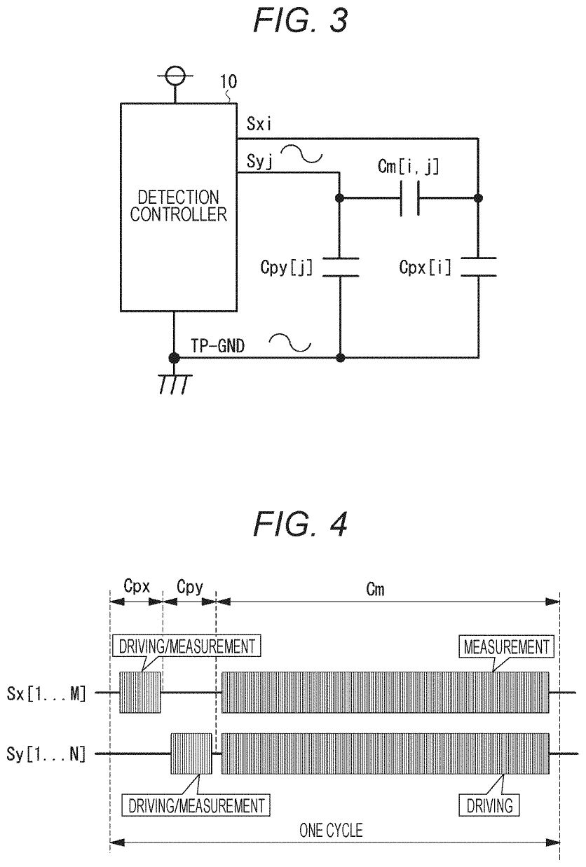

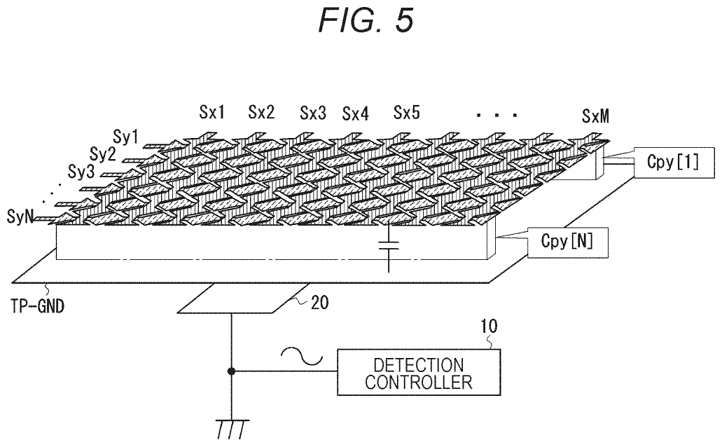

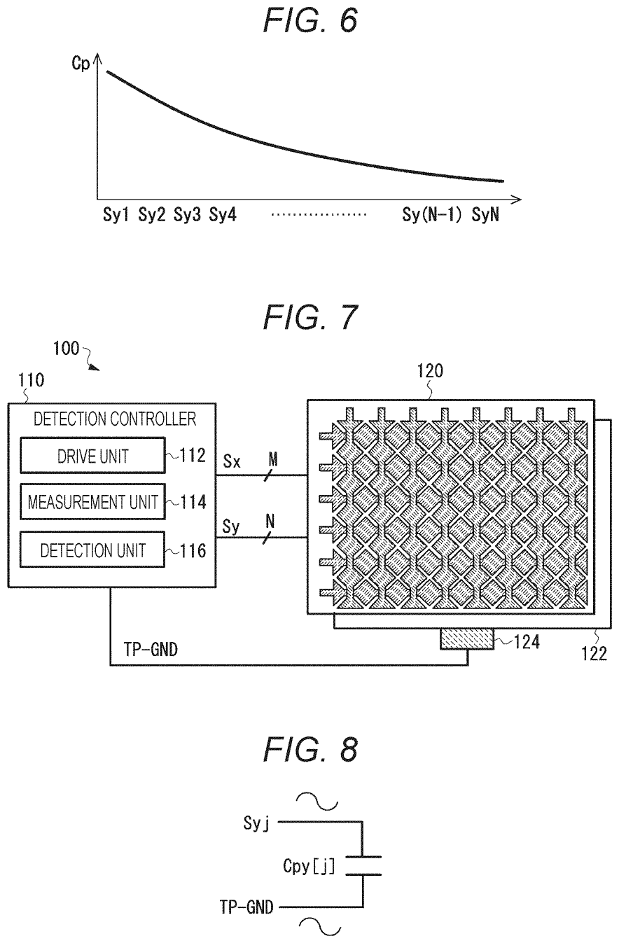

The touch panel 120 includes, for example, M pieces of sensor lines (Sx1, Sx2 . . . SxM) arranged in the X direction and N pieces of sensor lines (Sy1, Sy2, . . . , SyN) arranged in the Y direction, which are called diamond patterns as illustrated in FIG. 1, a TP-GND layer 122 having a substantially rectangular shape arranged below and facing the patterns of these sensor lines, and a connector 124 for electrically connecting the TP-GND layer 122 and the detection controller 110.

The TP-GND layer 122 is formed in a substantially rectangular shape made of a transparent metal material (for example, ITO or the like), for example, and is formed on a substrate made of glass, plastic, or the like. The connector 124 is attached to the bottom of the TP-GND layer 122, and the connector 124 electrically connects the signal line from the detection controller 110 to the TP-GND layer 122. The touch panel 120 is mounted on, for example, a liquid crystal panel (not illustrated), and provides a user input interface related to an image displayed on the liquid crystal panel.

The detection controller 110 controls the entire operation of touch panel 120. The detection controller 110 includes a drive unit 112 for driving each of the sensor line Sx on the X side and the sensor line Sy on the Y side, a measurement unit 114 for measuring the capacitances Cm, Cpx, and Cpy of each of the sensor line Sx on the X side and the sensor line Sy on the Y side, and a detection unit 116 for detecting a location touched by an operation target on the touch panel 120 based on a change in the capacitance Cm measured by the measurement unit 114 and detecting a hover location based on a change in the capacitance Cpx and Cpy.

The drive unit 112 includes an AC voltage generation unit for driving the X-side or Y-side sensor line and the TP-GND layer 122 with a sine wave (sinusoidal wave) when performing hover detection. The sine waves applied to the sensor line on the X side or the Y side and the TP-GND layer 122 as the drive signals have the same frequency, gain, and phase. As will be described later, the drive unit 112 changes the frequency of the sine wave generated by the AC voltage generation unit according to the location of the sensor line.

For example, as illustrated in FIG. 4, the detection controller 110 measures the capacitance Cpx of the sensor line itself on the X side and the capacitance Cpy of the sensor line itself on the Y side during one cycle, detects a hover based on a change in the capacitance, measures the capacitance Cm at the intersection of the sensor line Sx on the X side and the sensor line Sy on the Y side, and detects a touch based on a change in the capacitance. In the touch detection, it is assumed that the drive unit 112 drives the sensor line Sy on the Y side, and the measurement unit 114 measures the capacitance Cm in the sensor line Sx on the X side. However, the capacitance Cm may be measured in the sensor line Sy on the Y side by driving the sensor line Sx on the X side.

According to the present embodiment, when the hover detection is performed, the driving frequency of the sine wave for driving each of the sensor lines Sy is changed for each sensor line in accordance with the electrical characteristics of each path from the connector 124 to the sensor line Sy.

FIG. 8 illustrates sine waves that drive the sensor line Sy and TP-GND when the capacitance Cpy is measured. When the sensor line Sy is driven by the sine wave of the same frequency, the resistance of the TP-GND layer 122 increases as the distance from the connector 124 increases, and a cutoff frequency by an RC filter decreases (cutoff frequency=½ πRC). Therefore, when the frequency of the sine wave becomes larger than the cutoff frequency, attenuation of the sine wave becomes large on the upper side of the TP-GND layer 122.

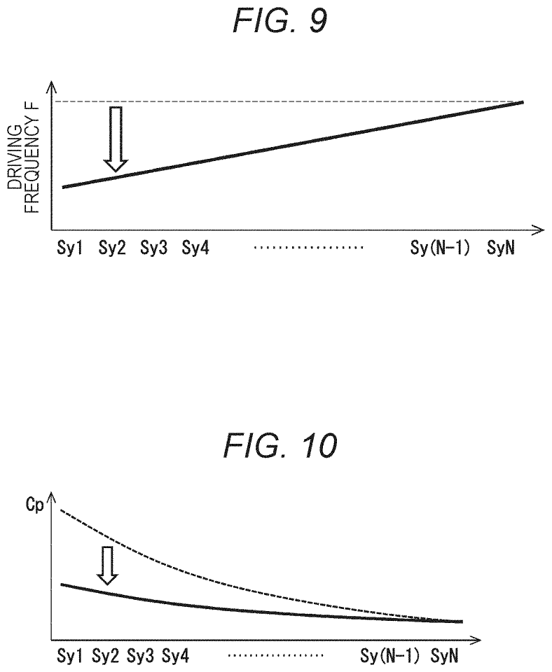

Therefore, according to the present embodiment, as illustrated in FIG. 9, the frequency of the sine wave at the time of driving the sensor line on the upper side (Sy1 side) is made lower than the frequency on the lower side (SyN side), and the attenuation of the sine wave is suppressed on the upper side of the TP-GND layer 122. The frequency of the sine wave is appropriately adjusted according to the electrical characteristics of the TP-GND layer 122 and the electrical measurement of the sensor lines on the X side and the Y side. If the frequency of the sine wave is lower than the cutoff frequency, the attenuation of the sine wave on the upper side of the TP-GND layer 122 can be made substantially 0, the difference between the sine wave of the sensor line and the sine wave of the TP-GND layer 122 can be made as small as possible, and the apparent parasitic capacitance Cpy can be reduced.

Specifically, when measuring the capacitance Cpy of the sensor line Sy in the Y direction, the drive unit 112 gradually increases the frequency F of the sine wave sequentially applied from the sensor line Sy1 to the sensor line SyN, or gradually decreases the frequency F of the sine wave sequentially applied from the sensor line SyN to the sensor line Syl. At this time, the sine wave having the same frequency as the sensor line Sy is applied to the TP-GND layer 122.

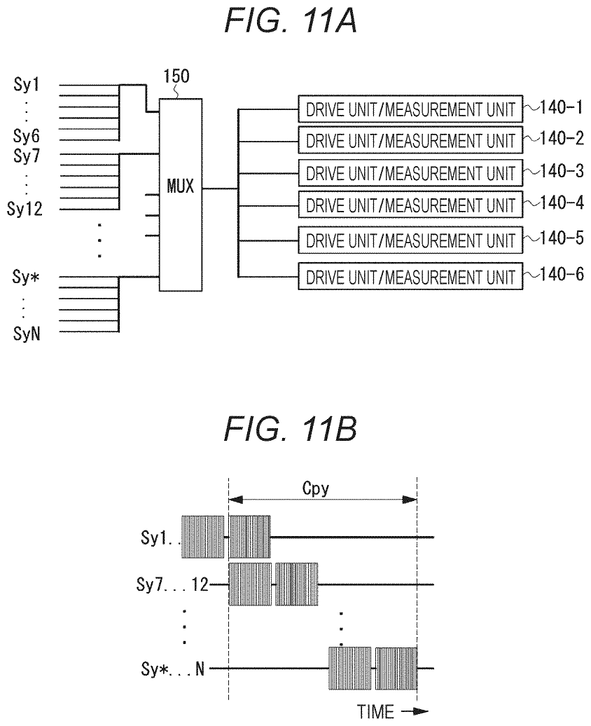

As described above, in the measurement of Cpy of the sensor line Sy on the upper side, the influence of the resistance R of the TP-GND layer 122 becomes larger, and the cutoff frequency of the RC filter with respect to the drive signal of the TP-GND layer 122 becomes lower (that is, the attenuation amount increases in signals of the same frequency). However, the attenuation amount is reduced by lowering the operation frequency of the sine wave, and the difference in the waveforms of the sine waves between the sensor line Sy at both ends of the capacitance Cpy and the TP-GND layer 122 is reduced. As a result, as illustrated in FIG. 10, the difference in apparent Cp measured between the upper side and the lower side of the touch panel 120 can be reduced. With this configuration, it is possible to reduce the sensitivity difference for each sensor line in the Y direction, that is, the sensitivity difference in the hover detection depending on the location in the touch panel 120.

Next, a second embodiment of the present invention will be described. Although the first embodiment illustrates an example in which each sensor line is driven at an individual frequency, the detection controller according to the second embodiment includes a plurality of drive units and measurement units therein, and simultaneously measures changes in capacitance of the plurality of sensor lines.

FIG. 11A is an example of measuring the capacitance Cpy of the sensor line Sy, in which the detection controller 110 includes, for example, six drive units/measurement units 140-1, 140-2, . . . , and 140-6 therein, and the drive units/measurement units 140-1 to 140-6 are simultaneously connected to each of the six sensor lines Sy selected by a selection circuit (multiplexer MUX) 150.

When the sensors of the sensor lines Sy1 . . . SyN are divided into k-pieces of blocks, as illustrated in FIG. 11B, the drive units/measurement units 140-1 to 140-6 are sequentially connected to the blocks of the sensor lines [Sy1 . . . Sy6], [Sy7 . . . Sy12], [Sy13 . . . Sy18] . . . [Sy(6 k-5) . . . SyN] in a time division manner via the selection circuit 150.

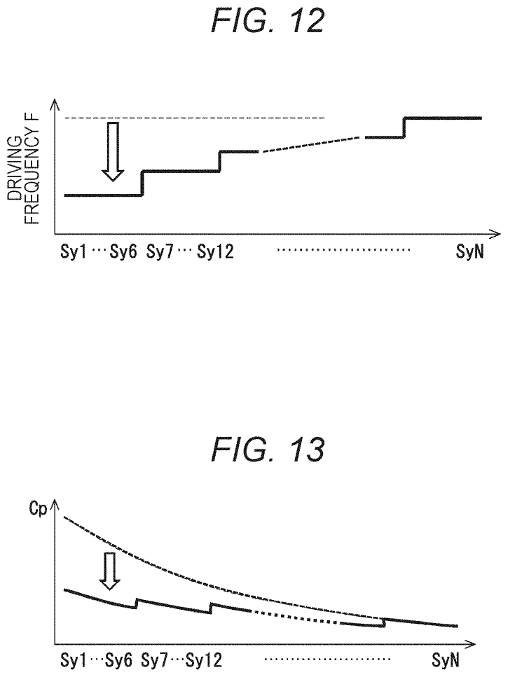

In the case of the present embodiment, the driving frequency of the sine wave at the time of driving each block is controlled to be lower in the upper side than in the bottom side as illustrated in FIG. 12. Although the six sensor lines in each block are driven at the same frequency (that is, the AC voltage generation circuit is shared), even in this case, by determining and operating the operation frequency of each block corresponding to the sensor having the average or maximum resistances R in the block, the difference in the capacitance Cp for each sensor line can be reduced as illustrated in FIG. 13. In addition, although the change in the Cp value is not smooth at the boundary (for example, a boundary between the sensor line Sy6 and the sensor line Sy7) of the block, this is not important, and it is important to reduce the capacitance Cp as a whole and to make more uniform the capacitance Cp in order to improve the sensitivity difference in the hover detection.

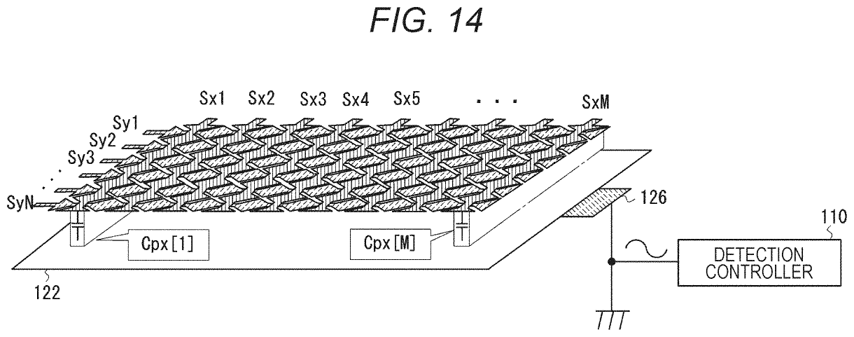

Next, a third embodiment of the present invention will be described. According to the first and second embodiments, the connector 124 is disposed at the center on the lower side of the TP-GND layer 122, but according to the third embodiment, as illustrated in FIG. 14, the connector 126 is attached to the center on the right side of the TP-GND layer 122. In such a configuration, the capacitance Cp changes in the measurement of each sensor line Sx due to the difference in the electrical path from the connector 126 to the sensor line Sx[1 . . . M] on the X side.

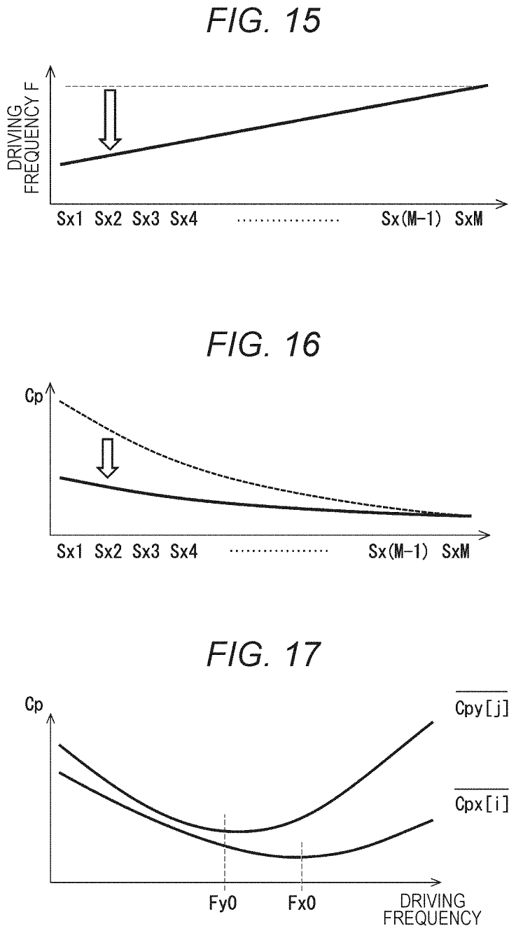

Therefore, according to the third embodiment, as illustrated in FIG. 15, by setting the driving frequency of the sensor line on the left side (Sx1 side) to a lower value than the driving frequency of the sensor line on the right side (SxM side), the attenuation amount of the measurement signal in the sensor line on the left side is reduced similarly to the first and second embodiments. As a result, as illustrated in FIG. 16, the difference between the apparent Cp values measured in the right sensor line and the left sensor line can be reduced, that is, the sensitivity difference for each sensor line on the X side is improved to be small.

Note that, according to the first and second embodiments, the connector 124 is attached to the center on the bottom side (SyN side) of the TP-GND layer 122; however, in a case where the connector 124 is attached to the center on the upper side (Sy1 side) of the TP-GND layer 122, a similar effect can be obtained by setting the driving frequency of the sensor line on the lower side to a lower value with respect to the upper side. In addition, according to the third embodiment, the connector 126 is attached to the center on the right side (SxM side) of the TP-GND layer 122, but in a case where the connector 126 is attached to the center on the left side (Sx1 side) of the TP-GND layer 122, a similar effect can be obtained by setting the driving frequency of the right sensor line to a low value with respect to the left side.

Next, a fourth embodiment of the present invention will be described. In a case where the number of measurement units in the detection controller 110 is larger than the number of sensors (M, N), blocking as in the second embodiment becomes unnecessary, but as illustrated in FIG. 4, the X-side sensor (Sx[1 . . . MD and the Y-side sensor (Sy[1 . . . N]) need to be driven at different times to measure Cpx[1 . . . M] and Cpy[1 . . . N]. At this time, due to the difference in the electric path to the TP-GND layer, Cpx of the X-side sensor and Cpy of the Y-side sensor measured in a case where the driving frequency is changed have different frequencies at which Cpx and Cpy values become very small, as illustrated in FIG. 17. In the drawing, /Cpx[i] and/Cpy[j] are an average value of all the sensor lines Sx and an average value of all the sensor lines Sy.

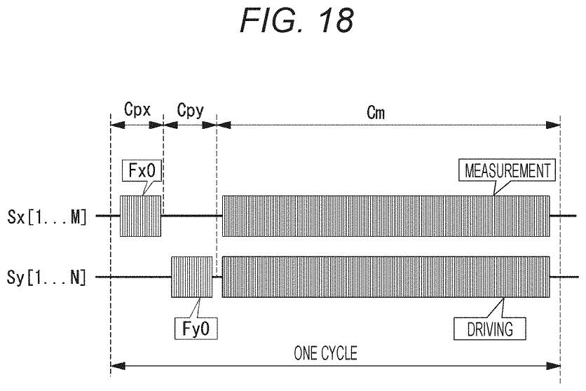

According to the present embodiment, by using such frequency characteristics, as illustrated in FIG. 18, by selecting different driving frequencies suitable for the X-side sensors Sx[1 . . . M] and the Y-side sensors Sy[1 . . . N] at the time of hover detection, such as the frequency Fx0 for the X-side sensors Sx[1 . . . M] and the frequency Fy0 for the Y-side sensors Sy[1 . . . N], the detection sensitivity of the X-side sensor Sx and the Y-side sensor Sy can be improved. Further, according to the present embodiment, the drive unit 112 of the detection controller 110 can be easily configured by fixing the driving frequency on the X side and the driving frequency on the Y side.

As described above, according to the present embodiment, by changing the driving frequency for each sensor line according to the electrical characteristics, the apparent parasitic capacitance measured for each sensor line can be reduced, and improvement and stabilization of the hover detection sensitivity can be realized.

According to the above embodiment, an example in which a sine wave (sinusoidal wave) is used as the drive signal has been described, but the present invention is not limited thereto, and a rectangular wave may be used as the drive signal. However, the sine wave has less radiation noise or emission noise than the rectangular wave, which is advantageous for EMI countermeasures.

Furthermore, according to the above embodiments, an example in which the hover detection and the touch detection are performed in a time division manner in one cycle has been described, but the present invention is not limited thereto, and only the hover detection may be performed by the capacitive touch panel, or the hover detection and the touch detection may be performed in different cycles.

While there has been illustrated and described what is at present contemplated to be preferred embodiments of the present invention, it will be understood by those skilled in the art that various changes and modifications may be made, and equivalents may be substituted for elements thereof without departing from the true scope of the invention. In addition, many modifications may be made to adapt a particular situation to the teachings of the invention without departing from the central scope thereof. Therefore, it is intended that this invention not be limited to the particular embodiments disclosed, but that the invention will include all embodiments falling within the scope of the appended claims.

What is claimed is:

1. A proximity detection device that detects an approach of an object, the proximity detection device comprising:
a touch panel including a plurality of sensor lines on an X side, a plurality of sensor lines on a Y side intersecting the plurality of sensor lines on the X side, a planar GND layer arranged to face the sensor lines on the X side and the Y side, and a connection portion electrically connected to a selected position of the GND layer; and
a detection unit configured to detect a hover (approach) of an object to the touch panel based on a change in capacitance formed between a selected sensor line on the X side or the Y side and the GND layer,
wherein when detecting a hover, the detection unit applies a drive signal to the selected sensor line on the X side or the Y side and applies a drive signal having the same waveform as the drive signal to the GND layer via the connection portion, and the detection unit further changes a frequency of the drive signal according to a position of the selected sensor line.

2. The proximity detection device according to claim 1, wherein the detection unit makes a frequency of the drive signal applied to a sensor line located away from the connection portion smaller than a frequency of a drive signal applied to a sensor line located closer to the connection portion.

3. The proximity detection device according to claim 2, wherein the detection unit selects a predetermined number of a plurality of sensor lines from the plurality of sensor lines, and simultaneously applies the drive signal to the selected plurality of sensor lines.

4. The proximity detection device according to claim 3, wherein the GND layer is rectangular and when the connection portion is connected to an upper side or a lower side of the rectangular GND layer, the detection unit changes a frequency of the drive signal applied to a sensor line extending in parallel with a direction of the upper side or the lower side.

5. The proximity detection device according to claim 3, wherein the GND layer is rectangular and when the connection portion is connected to a left side or a right side of the rectangular GND layer, the detection unit changes a frequency of the drive signal applied to a sensor line extending in parallel with the direction of the left side or the right side.

6. The proximity detection device according to claim 5, wherein the detection unit detects a touch on the touch panel based on a change in the capacitance formed at an intersection of the sensor line on the X side and the sensor line on the Y side, in addition to the hover detection.

7. The proximity detection device according to claim 6, wherein the detection unit performs the hover detection by the sensor line on the X side, the hover detection by the sensor line on the Y side, and the touch detection by the sensor lines on the X side and the Y side in one cycle.

8. The proximity detection device according to claim 1, wherein the drive signal is a sine wave (sinusoidal wave).

9. A display device comprising:
the proximity detection device according to claim 1; and
a display panel including the touch panel.

10. A hover detection method of a proximity detection device comprising a touch panel that includes a plurality of sensor lines on an X side, a plurality of sensor lines on a Y side intersecting the plurality of sensor lines on the X side, a planar GND layer arranged to face the sensor lines on the X side and the Y side, and a connection portion electrically connected to a selected position of the GND layer, the hover detection method comprising:
applying a drive signal to the selected sensor line on the X side or the Y side, applying a drive signal having the same waveform as the drive signal to the GND layer via the connection portion, and changing a frequency of the drive signal according to a position of the selected sensor line; and
detecting a hover of an object to the touch panel based on a change in capacitance formed between the selected sensor line on the X side or the Y side and the GND layer.

11. The hover detection method according to claim 10, wherein a frequency of the drive signal applied to the sensor line located away from the connection portion is made smaller than a frequency of the drive signal applied to a sensor line located closer to the connection portion.

12. The hover detection method according to claim 11, comprising selecting a predetermined number of a plurality of sensor lines from the plurality of sensor lines, and simultaneously applying the drive signal to the selected plurality of sensor lines.

13. The hover detection method according to claim 12, wherein the GND layer is rectangular and when the connection portion is connected to an upper side or a lower side of the rectangular GND layer, a frequency of the drive signal applied to a sensor line extending in parallel with a direction of the upper side or the lower side is changed.

14. The hover detection method according to claim 12, wherein the GND layer is rectangular and when the connection portion is connected to a left side or a right side of the rectangular GND layer, a frequency of the drive signal applied to a sensor line extending in parallel with the direction of the left side or the right side is changed.

15. The hover detection method according to claim 14, comprising detecting a touch on the touch panel based on a change in the capacitance formed at an intersection of the sensor line on the X side and the sensor line on the Y side, in addition to the hover detection.

16. The hover detection method according to claim 15, comprising detecting the hover detection by the sensor line on the X side, the hover detection by the sensor line on the Y side, and the touch detection by the sensor lines on the X side and the Y side in one cycle.

17. The hover detection method according to claim 10, wherein the drive signal is a sine wave (sinusoidal wave).

18. A proximity detection device that detects an approach of an object, the proximity detection device comprising:
a touch panel including a plurality of sensor lines on an X side, a plurality of sensor lines on a Y side intersecting the plurality of sensor lines on the X side, a rectangular GND layer arranged to face the sensor lines on the X side and the Y side, and a connection portion electrically connected to a selected position of the GND layer; and
a detection unit configured to detect a hover (approach) of an object to the touch panel based on a change in capacitance formed between a selected sensor line on the X side or the Y side and the GND layer,
wherein when detecting a hover, the detection unit applies a drive signal to the selected sensor line on the X side or the Y side and applies a drive signal having the same waveform as the drive signal to the GND layer via the connection portion, and the detection unit further changes a frequency of the drive signal according to a position of the selected sensor line to make a frequency of the drive signal applied to a sensor line located away from the connection portion smaller than a frequency of a drive signal applied to a sensor line located closer to the connection portion, and
wherein when the connection portion is connected to an upper side or a lower side of the GND layer, the detection unit changes a frequency of the drive signal applied to a sensor line extending in parallel with a direction of the upper side or the lower side, and when the connection portion is connected to a left side or a right side of the GND layer, the detection unit changes a frequency of the drive signal applied to a sensor line extending in parallel with the direction of the left side or the right side.

19. The proximity detection device according to claim 18, wherein the detection unit selects a predetermined number of a plurality of sensor lines from the plurality of sensor lines, and simultaneously applies the drive signal to the selected plurality of sensor lines.

20. The proximity detection device according to claim 18, wherein the detection unit detects a touch on the touch panel based on a change in the capacitance formed at an intersection of the sensor line on the X side and the sensor line on the Y side, in addition to the hover detection, and the detection unit performs the hover detection by the sensor line on the X side, the hover detection by the sensor line on the Y side, and the touch detection by the sensor lines on the X side and the Y side in one cycle.
